(19) United States
(12) Patent Application Publication
(10) Pub. No.: US 2008/0301054 A1
(43) Pub. Date: Dec. 4, 2008

(54) Station For Sale of Digital Media

(75) Inventors: Stephen A. Russell, St. Paul, MN (US); Eric Dahlen, Las Vegas, NV (US); Robert French, Woodbury, MN (US); Christopher Huber, Stillwater, MN (US)

Correspondence Address: ROTHWELL, FIGG, ERNST & MANBECK, P.C., 1425 K STREET, N.W., SUITE 800, WASHINGTON, DC, 20005, US

(73) Assignee: TRANS WORLD NEW YORK LLC, Albany, NY (US)

(21) Appl. No.: 11/996,875

(22) PCT Filed: Jul. 26, 2006
(86) PCT No.: PCT/US06/28913

§ 371 Date: Jun. 12, 2008

Related U.S. Application Data
(60) Provisional application No. 60/702,905, filed on Jul. 27, 2005.

(51) Int. Cl. G06Q 30/00; G06Q 50/00

(52) U.S. Cl. 705/59; 705/26

(57) ABSTRACT

A system for selling digital media, comprising: a content server for providing a master source of digital content to the system; a retail server for maintaining a local cache of popular content, and for packaging content; a license server for maintaining licenses for each piece of digital content wherein the license server issues new licenses to the retail server at the time of sale and issues subsequent licenses to a consumer for extending content usage; a plug-in for accessing digital content in a single click; and a media tablet for providing a consumer interface for exploring the digital content of the system, the media tablet comprising an interface for connection by a portable device for content transfer; means for accepting payment; and means for interacting with the retail server.

### RELATED APPLICATION

This application claims the benefit of U.S. Provisional Application No. 60/702,905, filed Jul. 27, 2005, which application is incorporated herein by reference.

### COPYRIGHT

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2006, Mix & Burn, Inc.

### FIELD

Embodiments of the invention described herein relate to a “digital filling station” system for enabling the sale of digital media directly to portable devices in the retail environment. This system delivers rights-managed content, and provides extended licensing so that the portable device content is also retrieved from the device and is usable in other ways, subject to valid license retrieval.

### DESCRIPTION OF THE FIGURES

FIG. 1 illustrates one schematic embodiment of the digital filling station of the invention.

### DESCRIPTION

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Herein, block diagrams illustrate exemplary embodiments of the invention. Also herein, flow diagrams illustrate operations of the exemplary embodiments of the invention. The operations of the flow diagrams are described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel.

Embodiments of the invention described herein relate to a “digital filling station” system for enabling the sale of digital media directly to portable devices in the retail environment. This system delivers rights-managed content, and provides extended licensing so that the portable device content is also retrieved from the device and is usable in other ways, subject to valid license retrieval.

### Digital Rights Management Model

A digital rights management (DRM) scheme includes the following features:
Content Provider—The master source of digital media, be it the creator of the content, or a licensed distributor.
Content Packager—The component that encrypts the content and packages it with its licensing information.
Content Distributor—The component that delivers the licensed content to the consumer or device (the Player component).
License Issuer—The central repository of all licensing data and rights rules. License requests are made to this component.
Player—The device or software application that renders the digital media for its intended use (audio player, video player, e-book viewer, etc. . . . ).
System Components for One DRM embodiments:

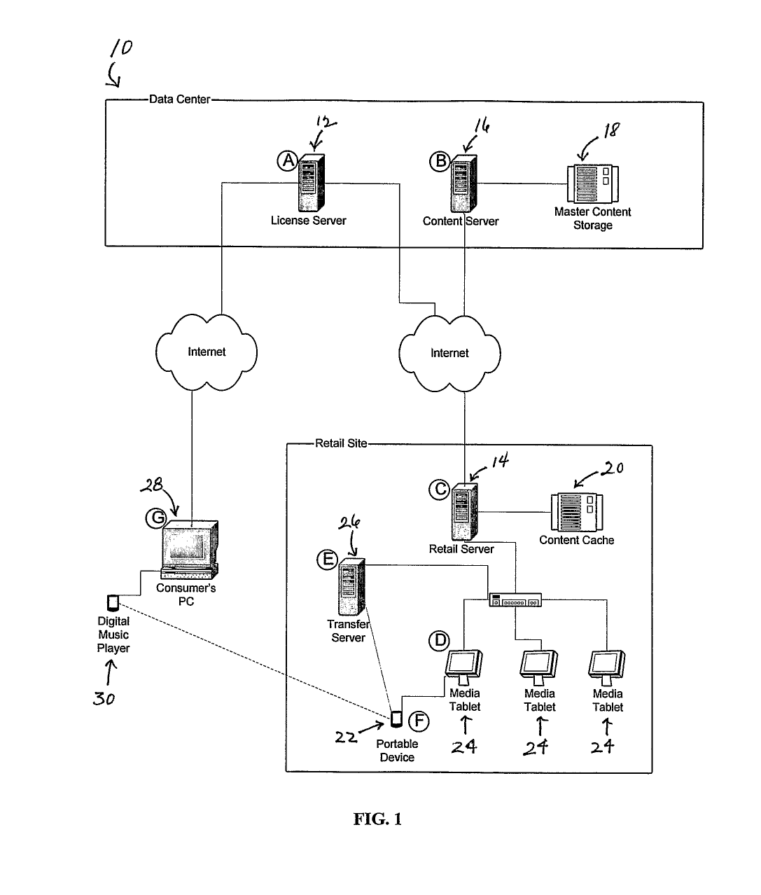

Components of a system embodiment, illustrated generally at 10 in FIG. 1 include the following:

A: License Server 12. The License Server 12 maintains the licenses for each piece of digital content that has been sold. The license server 12 issues new licenses to a Retailer Server 14 for each piece of content at the time of sale, and the license server 12 also issues subsequent licenses to a consumer for automatically extending the consumer's usage of the purchased content based on the license that has already been purchased in the store.

B: Content Server 16. The Content Server 16 provides a master source of digital content 18 to the entire system 10. As such, the content server 16 represents one or more content providers in the digital rights management model. The content server 16 is also responsible for the protection of the content, with respect to digital rights, but independently of any published DRM mechanism.

C: Retail Server 14. The Retailer Server 14 maintains a local cache of the most popular content 20; packages the content for delivery to a digital device such as is shown at 22, including the application of the appropriate digital rights management overhead; and interacts with the License Server 12 to generate/record licenses.

D: Media Tablet 24. The Media Tablet 24 provides a customer interface for exploring the available catalog of digital content, previewing the content as applicable and selecting items for purchase. The media tablet also acts as a physical interface that the portable device 22 is connected to for the transfer of content. For some embodiments, the Media Tablet 24 accepts payment for the content, and it interacts with lithe Retail Server 14 to request a rights-managed content package which it then downloads to the attached Portable Device 22.

E: Transfer Server 26. The Transfer Server 26 is an optional component. The transfer server 26 provides a central, retailer controlled, filling station for the Portable Device or devices 22. Instead of physically connecting to the Media Tablet 24, the Portable Device 22 connects to the Transfer Server 26 for the downloading of the content. The transfer server 26 is used, for some embodiments, in retailer settings in which the retailer “owns” the customer. Thus, for these embodiments, accepting payment at the Media Tablet 24 is not allowed.

F: Portable Device 22. The portable device 22 is a recipient of the purchased digital content. It must be a digital rights management (DRM) capable device, with a DRM scheme that is supported by the system.

G: Consumer's PC 28. The consumer's personal computer (PC) is used for some embodiments. It is assumed that the consumer owner of the Portable Device 22, such as a digital music player 30 has access to a computer 28 and a means of connecting the Portable Device 22 or 30 to this computer 28. The Consumer PC 28 uploads the digital content from the Portable Device 22 or 30 to be stored on the PC 28. The Consumer PC 28 also interacts with the License Server 12 in order to acquire any additional licensed usage capabilities including the automatic acquisition of any licensing that was already purchased at retail

The components described herein map into a DRM model as follows:

| | Content | Content | Content | | |
|---|---|---|---|---|---|
| | Pro- | Pack- | Distri- | License | |
| | vider | ager | butor | Issuer | Player |
| A: License Server | | | | X | |
| B: Content Server | X | | | | |
| C: Retail Server | | X | X | | |
| D: Media Tablet | | | X | | |
| E: Transfer Server | | | X | | |
| F: Portable Device | | | | | X |
| G: Consumer PC | | | | | X |

### EXAMPLES

Examples described herein are presented to describe exemplary embodiments of inventive subject matter but are not presented to limit the subject matter.

Purchase at Retail using Media Tablet

Using the Media Tablet 24, Consumer selects content to be purchased. Media Tablet 24 prompts Consumer to connect Portable Device 22. Media Tablet 24 validates that the Portable Device 22 is compatible with a supported rights-management scheme, and that it has enough remaining storage space for the requested content.

Consumer swipes credit card, and Media Tablet 24 completes the payment transaction successfully.

Media Tablet 24 requests the content from the Retail Server 14. Retail Server 14 requests content download from Content Server 16 for items not already in its local content cache.

Content Server 16 validates the request for content. Retail Server 14 must present an authentication request and its identity must be known and enabled in the system database.

Retail Server 14 downloads content.

Retail Server 14 requests decryption keys from Content Server 16.

Content Server 16 validates the request for keys. Retail Server 14 must present an authentication request and its identity must be known and enabled in the system database.

Retail Server 14 receives decryption keys over SSL using 128-bit encryption. Retail Server 14 uses the decryption keys to decrypt the content and temporarily store it locally.

Retail Server 14 generates license for each piece of content. Retail Server 14 sends these new licenses to License Server 12 over SSL using 128-bit encryption.

Retail Server 14 encrypts the content with the license information, which includes the usage rules and the internet location of the License Server 12 by which further licenses can be retrieved.

Retail Server 14 notifies Media Tablet 24 of the availability of the content.

Media Tablet 24 downloads the rights-managed content from the Retail Server 14.

Media Tablet 24 writes the rights-managed content to the attached Portable Device 22 or 30.

### Extended Usage

Consumer attaches Portable Device 30 or 22 to PC 28, using connection hardware provided by the device manufacturer.

Consumer copies rights-managed content from the device to the PC 28 hard drive, using the file system integration if applicable, [or] using software supplied by the device manufacturer, or using a third-party content player such as Windows Media Player or Apple Computer's iTunes.

Consumer tries to open the rights-managed content using associated software such as an audio player (e.g. Windows Media Player or iTunes).

If the software does not support the rights-management scheme, it will not open the content.

If the software does support the rights-management scheme, it will invoke the License Server 12 at the location embedded into the content including headers that were created at the time of purchase. The headers allow the license server to identify the purchase and automatically extend the license based on the consumers retail purchase.

License Server 12 validates the request and replies with a new license issuance or a denial.

If license was issued, software updates its license storage and opens the content.

For some embodiments, the station for sale of digital media includes a Windows Media Player, version 10 or above, plug-in feature. For some embodiments, the Media Player plug-in enables access to content in a one-click operation. Stores that provide content accessible by the plug-in include but are not limited to MSN Music, Napster, CinemaNow, MusicNow, MusicMatch, Wal-Mart, Court TV Extra, f.y.e. download zone, PureTracks, audible,com, MLB.com, Live365, PassAlong, SongTouch, and MovieLink.

The plug-in is also usable to play and organize music and videos that have been downloaded. The plug in is usable to mix and match to create playlists, rate songs and albums, burn CDs, and aid in a selection of portable devices. The plug-in permits automatic or manual synchronization of digital media to the device. With the plug-in device, no driver installation is required. The plug-in also has smart jukebox features that include monitoring changes to a digital media collection automatically; play, sync, or burn digital media quickly with auto playlists; organizing digital media by ratings; and tagging media.

An additional embodiment utilizes Apple Computer's iTunes digital media player on the Media Tablet 24 for the sale of digital media. This embodiment may utilize the iTunes music store service provided by Apple Computer as the source of rights-managed content.

1. A system for selling digital content comprising:
a content server for providing a master source of digital content;
a retail server for maintaining a local cache of digital content or popular digital content, and for packaging the digital content;
a license server for maintaining licenses for each piece of digital content; and a media tablet for providing a consumer interface for accessing the digital content of the system.

2. The system of claim 1, wherein:
the license server issues new licenses to the retail server at the time of sale and issues subsequent licenses to a consumer for extending content usage.

3. The system of claim 1, wherein the media tablet further comprises:
an interface for connection by a portable device for content transfer;
a mechanism for accepting payment; and
a mechanism for interacting with the retail server.

4. The system of claim 1, further comprising:
a portable device for receiving purchased digital content.

5. The system of claim 4, wherein:
the portable device supports digital rights management capabilities.

6. The system of claim 4, further comprising:
a transfer server for connecting to the portable device.

7. The system of claim 4, wherein:
the Media Tablet downloads the rights-managed content from the Retail Server.

8. The system of claim 7, wherein:
the Media Tablet uploads the rights-managed content to the Portable Device.

9. The system of claim 1, further comprising:
a software plug-in for accessing digital content.

10. The system of claim 9, wherein:
the plug-in enables one click access to digital content.

11. The system of claim 9, wherein:
the plug-in is for Windows Media Player, version 10 or greater.

12. The system of claim 1, wherein:
the Media Tablet utilizes Apple Computer's iTunes software to enable the selection and purchase of digital content.

13. The system of claim 12, wherein:
Apple Computer's iTunes digital content store is a source of rights-managed content available for purchase.

14. The system of claim 1, further comprising:
a personal computer which interacts with the license server in order to extend the use of purchased digital content.

15. The system of claim 1, wherein:
the license server issues or validates subsequent licenses to a consumer for extending content usage.

16. The system of claim 1, wherein:
the Retail Server generates a license for each piece of content purchased.

17. The system of claim 1, wherein:
the Retail Server sends new licenses to the License Server over SSL using encryption.

18. The system of claim 1, wherein:
the Retail Server encrypts content with the license information, which includes usage rules and an internet address (URL) of the License Server.

19. A method for purchasing digital content, comprising:
selecting digital content using the media tablet of claim 1;
connecting a portable device to the media tablet;
downloading the digital content to a portable device; and
processing payment for the digital content.

20. The method of claim 19, wherein:
the media tablet validates that the portable device is compatible with a supported rights-management scheme.

21. The method of claim 19, wherein:
the digital content selection and downloading are facilitated by a software plug-in.

22. The method of claim 21, wherein:
the software plug-in is for the Windows Media Player, version 10 or greater.

23. (canceled)

24. A method for uploading previously rights-managed digital content on to a personal computer, comprising:
connecting a portable device containing rights-managed content to the personal computer;
manually or automatically uploading the content from the portable device to the personal computer;
manually or automatically recognizing the rights-managed content on the personal computer;
reading the digital rights management license information stored within the content;
using the license information to contact the remote license server to request access; and
receiving license information from the remote license server enabling local use.
